(19) United States
(12) Patent Application Publication
(10) Pub. No.: US 2026/0152287 A1
(43) Pub. Date: Jun. 4, 2026

(54) INTAKE DUCT, GAS TURBINE ENGINE, AND FLYING OBJECT

(71) Applicant: HONDA MOTOR CO., LTD., Tokyo (JP)

(72) Inventors: Azuki Ichikawa, Wako-shi (JP); Yuichi Fukuchi, Wako-shi (JP)

(21) Appl. No.: 19/404,714

(22) Filed: Dec. 1, 2025

(30) Foreign Application Priority Data
Dec. 4, 2024 (JP) 2024-211091

(51) Int. Cl. B64D 33/02; F02C 7/04

(52) U.S. Cl. CPC B64D 33/02; F02C 7/04

(57) ABSTRACT

An intake duct includes a rear wall, a front wall, and a side wall. A duct space defined by the rear wall, the front wall, and the side wall includes a first partial space and a second partial space. The second partial space is located on one side of the first partial space, and at least a part of a partial side wall, which is a part of the side wall, is located on the other side of the first partial space. The shape of the at least part of the partial side wall is a spiral shape when viewed in the axial direction of a gas turbine engine.

### CROSS-REFERENCE TO RELATED APPLICATIONS

This application is based upon and claims the benefit of priority from Japanese Patent Application No. 2024-211091 filed on Dec. 4, 2024, the contents of which are incorporated herein by reference.

### BACKGROUND OF THE INVENTION

### Field of the Invention

The present disclosure relates to an intake duct, a gas turbine engine, and a flying object.

Description of the Related Art

JP 6661323 B2 discloses an intake structure of a compressor incorporated in a gas turbine engine. An intake duct provided in the intake structure includes an intake port that opens in a direction away from the central axis of the compressor.

### SUMMARY OF THE INVENTION

It is desired to introduce air into the compressor in a more favorable manner.

The present disclosure has the object of solving the above-described problem.

According to a first aspect of the present disclosure, there is provided an intake duct that guides air to a compressor of a gas turbine engine, the intake duct comprising: a rear wall provided with an opening in which an introduction path is disposed, the introduction path being configured to introduce the air into the compressor; a front wall facing the rear wall; and a side wall configured to connect the rear wall and the front wall, wherein a duct space defined by the rear wall, the front wall, and the side wall includes a first partial space including a center of the opening, and a second partial space configured to guide, to the first partial space, the air flowing in the second partial space via an intake port, the second partial space is located on one side of the first partial space, at least a part of a partial side wall, which is a part of the side wall, is located on another side of the first partial space, and a shape of the at least part of the partial side wall is a spiral shape when viewed in an axial direction of the gas turbine engine.

According to a second aspect of the present disclosure, there is provided a gas turbine engine comprising the intake duct according to the first aspect.

According to a third aspect of the present disclosure, there is provided a flying object comprising a plurality of the gas turbine engines according to the second aspect, wherein the plurality of gas turbine engines are arranged in parallel inside a fuselage.

According to the present disclosure, air can be introduced into a compressor in a favorable manner.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a power generation unit;

FIG. 2 is a plan view of the power generation unit;

FIG. 3 is a side view of the power generation unit;

FIG. 4 is a cross-sectional view taken along line IV-IV of FIG. 3;

FIG. 5 is a cross-sectional view taken along line V-V of FIG. 3;

FIG. 6 is a diagram for explaining the shape of a partial side wall as viewed in the axial direction;

FIG. 7 is a diagram showing an allowable range of the partial side wall;

FIG. 8 is a diagram showing a flow of air in an intake duct;

FIG. 9 is a diagram showing another base circle; and

FIG. 10 is a schematic diagram of a flying object.

### DETAILED DESCRIPTION OF THE INVENTION

In a gas turbine engine, air (outside air) flows into an intake duct from an intake port, and is guided, by the intake duct, to an inlet (also referred to as an introduction port) of an introduction path through which air is introduced into a compressor. Incidentally, unevenness of the intake air in the compressor causes deterioration of the output of the gas turbine engine and engine stall. The unevenness of the intake air in the compressor is remarkable in, for example, a gas turbine engine having a side air intake structure.

In the gas turbine engine having the side air intake structure, the intake port opens in one direction (referred to as a +d direction) orthogonal to an axis of the gas turbine engine. Further, the introduction port is formed in an annular shape centered on the axis of the gas turbine engine. The air flows through the intake duct from the intake port toward the introduction port along a plane perpendicular to the axis of the gas turbine engine. Further, the air that has reached the introduction port changes its flow direction by about 90 degrees and flows through the introduction path along the axial direction of the gas turbine engine. In this manner, the air is introduced into the compressor.

In the intake duct, a part of the air flows into the introduction path from a +d direction. In addition, in the intake duct, another part of the air flows along the periphery of the introduction port and flows into the introduction path from a direction other than the +d direction. For example, the other part of the air bypasses the introduction port by 180 degrees and flows into the introduction path from a direction (referred to as a −d direction) opposite to the +d direction. Unevenness is likely to occur between the flow rate of the air flowing into the introduction path from the +d direction and the flow rate of the air flowing into the introduction path from the −d direction. For this reason, in the gas turbine engine having the side air intake structure, unevenness of the intake air is likely to occur in the compressor.

According to the embodiment described below, in a gas turbine engine having a side air intake structure, it is possible to suppress unevenness of intake air in a compressor.

### 1. Power Generation Unit 10

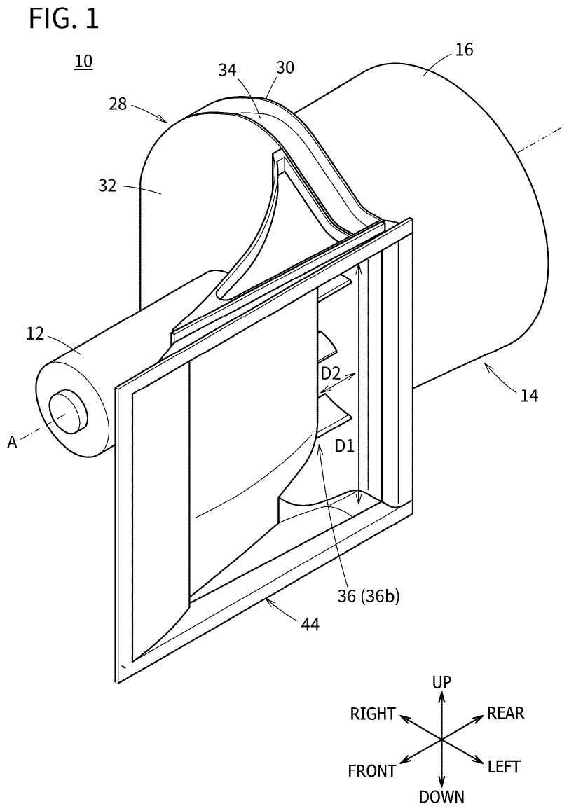

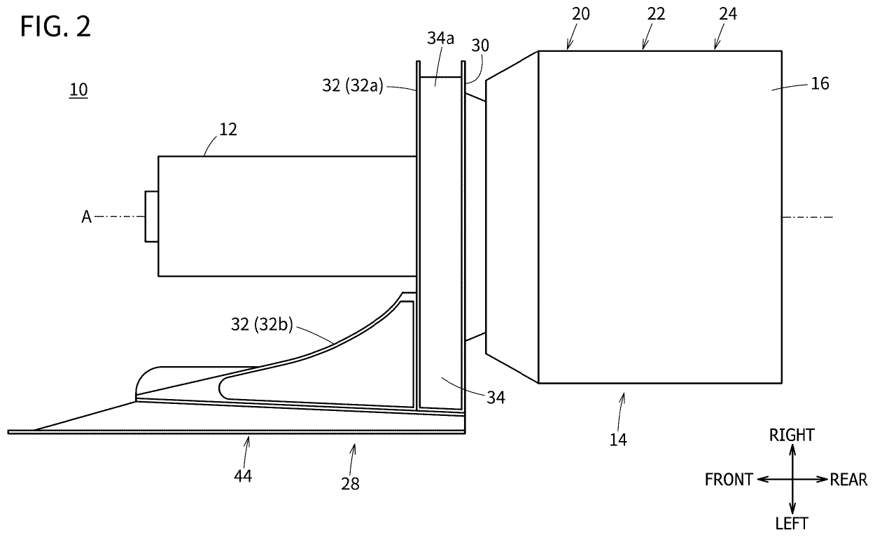

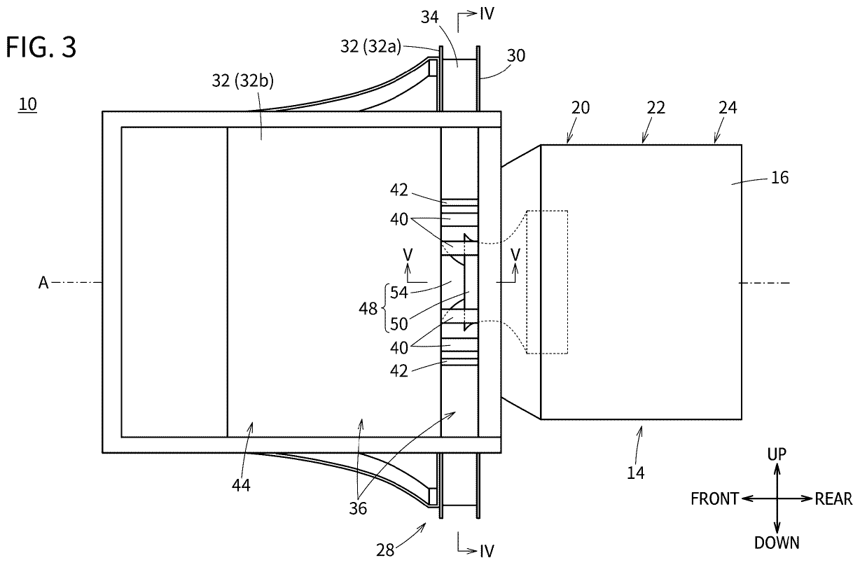

FIG. 1 is a perspective view of a power generation unit 10. FIG. 2 is a plan view of the power generation unit 10. FIG. 3 is a side view of the power generation unit 10. Note that, for convenience of description, directions such as front and rear, up and down, and left and right are used herein. Further, the power generation unit 10 in which an axis A of the power generation unit 10 extends in the front-rear direction will be described herein. That is, the axial direction of the power generation unit 10 coincides with the front-rear direction. However, the axial direction of the power generation unit 10 is not limited to the front-rear direction. That is, the posture of the power generation unit 10 is not limited to a specific posture.

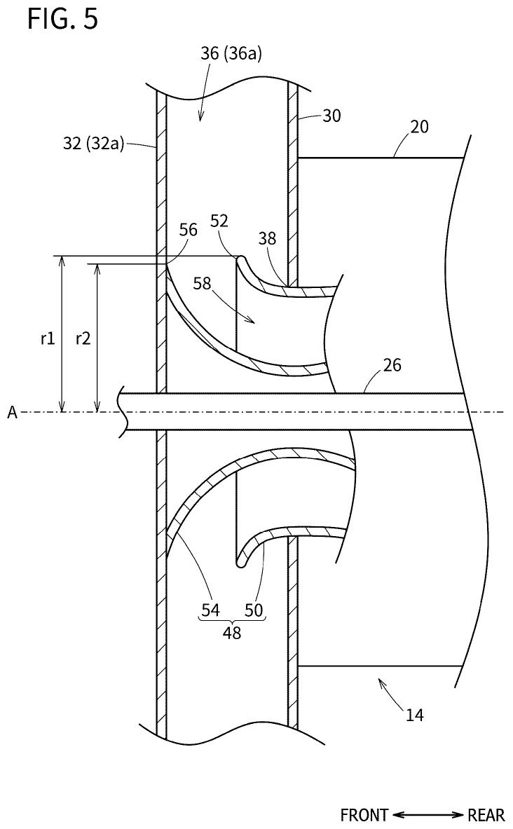

The power generation unit 10 includes a generator 12, and a gas turbine engine 14 having a side air intake structure. The generator 12 is disposed forward of the gas turbine engine 14. A rotating shaft (not shown) of the generator 12 and a shaft 26 (FIG. 5) of the gas turbine engine 14 are each disposed on the axis A of the power generation unit 10. The axis A of the power generation unit 10 is also the axis of each of the generator 12 and the gas turbine engine 14. The axis of the generator 12 and the axis of the gas turbine engine 14 are referred to herein as the axis A. The rotating shaft of the generator 12 is connected to the shaft 26 (FIG. 5) of the gas turbine engine 14. The rotation of the shaft 26 of the gas turbine engine 14 causes the rotating shaft of the generator 12 to rotate. As a result, the generator 12 generates electric power.

### 2. Gas Turbine Engine 14

As shown in FIGS. 2 and 3, the gas turbine engine 14 includes a compressor 20, a combustor 22, and a turbine 24. Note that FIGS. 1 to 3 illustrate the compressor 20, the combustor 22, and the turbine 24 in a state of being covered with a cover 16. The compressor 20, the combustor 22, and the turbine 24 are arranged in the front-rear direction. The compressor 20 is disposed forward of the combustor 22. The combustor 22 is disposed forward of the turbine 24. The rotation of the turbine 24 causes the shaft 26 (FIG. 5) of the gas turbine engine 14 to rotate.

### 3. Intake Duct 28

As shown in FIGS. 2 and 3, for example, the gas turbine engine 14 includes an intake duct 28. The intake duct 28 is disposed forward of the compressor 20 and rearward of the generator 12. The intake duct 28 is connected to the compressor 20 and the generator 12. The intake duct 28 includes a rear wall 30, a front wall 32, and a side wall 34. Each of the rear wall 30, the front wall 32, and the side wall 34 is a casing member that defines a duct space 36 serving as an air flow path inside the intake duct 28.

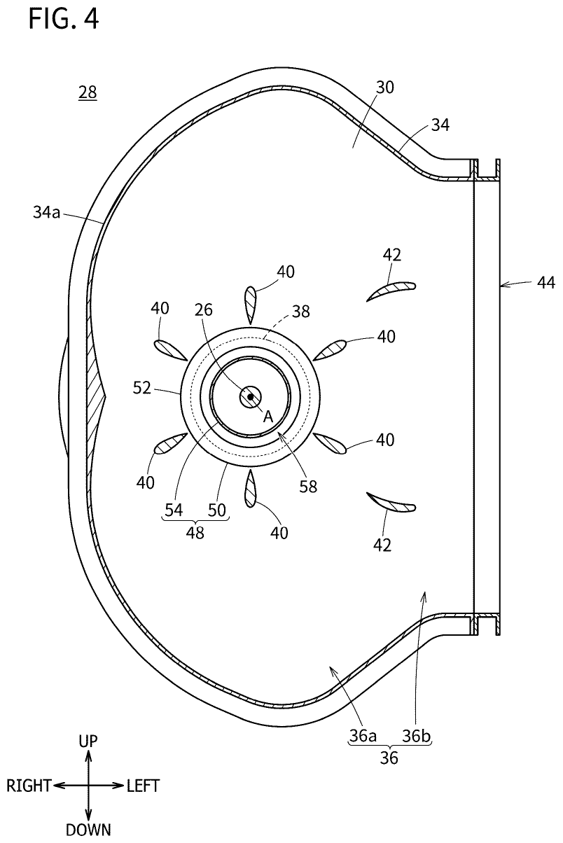

FIG. 4 is a cross-sectional view taken along line IV-IV of FIG. 3. FIG. 5 is a cross-sectional view taken along line V-V of FIG. 3. The rear wall 30 intersects the axis A. An opening 38 centered on the axis A is formed in the rear wall 30. A bell mouth 48, which will be described later, is attached to the opening 38.

As shown in FIG. 2, the front wall 32 is disposed forward of the rear wall 30. The front wall 32 includes a partial front wall 32a located on the right side, and a partial front wall 32b located on the left side. The partial front wall 32a intersects the axis A. The partial front wall 32a extends along the rear wall 30 and faces the rear wall 30. On the other hand, the partial front wall 32b is partially curved. The partial front wall 32b extends obliquely forward to the left from a connection portion with the partial front wall 32a.

As shown in FIGS. 1 to 3, the side wall 34 is disposed between the rear wall 30 and the front wall 32 in the front-rear direction. The side wall 34 connects a part of the peripheral edge of the rear wall 30 excluding the peripheral edge thereof on the left side, and a part of the peripheral edge of the front wall 32 excluding the peripheral edge thereof on the left side. As shown in FIGS. 2 and 4, a portion of the side wall 34 that is located on the right side (a part of the side wall 34) is referred to as a partial side wall 34a.

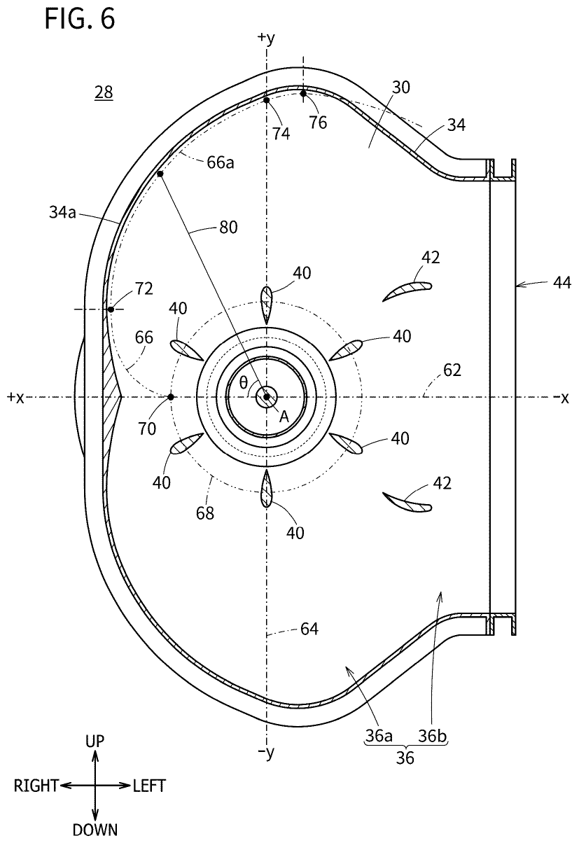

As shown in FIG. 4, the intake duct 28 includes a plurality of struts 40. The struts 40 have an airfoil shape. Examples of the airfoil shape include a NACA0012 shape. The plurality of struts 40 are disposed inside the duct space 36. The plurality of struts 40 are arranged at intervals from each other on a predetermined circle centered on the axis A. The predetermined circle is a base circle 68 (FIG. 6) of an involute curve 66 described later. The struts 40 are arranged along the radial direction of the base circle 68 when viewed in the axial direction. The struts 40 are disposed outside the opening 38 when viewed in the axial direction. The struts 40 connect the rear wall 30 and the front wall 32 (the partial front wall 32a).

As shown in FIG. 4, the intake duct 28 includes a pair of guide vanes 42. The pair of guide vanes 42 are disposed inside the duct space 36. One guide vane 42 is disposed above the other guide vane 42. The guide vanes 42 are disposed between the opening 38 (and the base circle 68 shown in FIG. 6) and an intake port 44. The guide vanes 42 straighten the flow of the air flowing into the duct space 36 from the intake port 44. The guide vanes 42 are connected to the rear wall 30 and the front wall 32 (the partial front wall 32a).

As shown in FIG. 4, the intake port 44 that opens leftward is formed on the left side of the intake duct 28. The duct space 36 communicates with an external space via the intake port 44. The duct space 36 includes a first partial space 36a and a second partial space 36b. The first partial space 36a is located on the right side (the other side) in the duct space 36. When viewed in the axial direction, the first partial space 36a includes the center of the opening 38 located on the axis A. The second partial space 36b is located on the left side (one side) in the duct space 36. The second partial space 36b is adjacent to the intake port 44. The second partial space 36b guides the air flowing therein through the intake port 44, to the first partial space 36a.

In this specification, the boundary between the first partial space 36a and the second partial space 36b is present between the leftmost strut 40 among the plurality of struts 40 and the guide vanes 42. That is, the respective struts 40 are disposed inside the first partial space 36a. Further, the respective guide vanes 42 are disposed inside the second partial space 36b.

A dimension D1 (FIG. 1) of the second partial space 36b in the up-down direction decreases with increasing distance from the first partial space 36a. On the other hand, a dimension D2 (FIG. 1) of the second partial space 36b in the front-rear direction (the axial direction) increases with increasing distance from the first partial space 36a. In the present embodiment, in at least a part of the second partial space 36b, the amount of change in the cross-sectional area of the second partial space 36b in accordance with the change in the dimension D1 is substantially equal to the amount of change in the cross-sectional area of the second partial space 36b in accordance with the change in the dimension D2. That is, in the at least part of the second partial space 36b, the cross-sectional shape of the second partial space 36b changes with increasing distance from the first partial space 36a, whereas the cross-sectional area of the second partial space 36b is constant. The cross section mentioned here is a cross section along the front-rear direction and the up-down direction.

As shown in FIG. 5, the bell mouth 48 is attached to the opening 38 formed in the rear wall 30. The bell mouth 48 includes an outer shroud 50 and an inner shroud 54. The connection portion between the inner edge portion of the rear wall 30 and the outer edge portion of the outer shroud 50 around the opening 38 is sealed. A distal end portion 52 of the outer shroud 50 is disposed inside the first partial space 36a. A proximal end portion (not shown) of the outer shroud 50 is fixed to a member (not shown) disposed on the rear side. A distal end portion 56 of the inner shroud 54 is located forward of the distal end portion 52 of the outer shroud 50. The distal end portion 56 of the inner shroud 54 is disposed inside the first partial space 36a and is fixed to the partial front wall 32a. A proximal end portion (not shown) of the inner shroud 54 is fixed to a member (not shown) disposed on the rear side.

The outer shroud 50 and the inner shroud 54 define an annular introduction path 58 for introducing air into the compressor 20. The introduction path 58 allows communication between the duct space 36 and an internal space (a space in which an impeller is disposed) of the compressor 20.

### 4. Shape of Partial Side Wall 34a

FIG. 6 is a diagram for explaining the shape of the partial side wall 34a as viewed in the axial direction. The shape of the partial side wall 34a as viewed in the axial direction will be described below. Here, a first imaginary line 62 extending in the left-right direction and orthogonal to the axis A, and a second imaginary line 64 extending in the up-down direction and orthogonal to the axis A, are assumed. The side wall 34 of the present embodiment has a shape that is line symmetrical about the first imaginary line 62. Here, the shape of the partial side wall 34a located above the first imaginary line 62 will be described, and the description of the partial side wall 34a located below the first imaginary line 62 will be omitted.

With reference to the first partial space 36a, the second partial space 36b is located on the left side of the first partial space 36a. Further, with reference to the first partial space 36a, at least a part of the partial side wall 34a is located on the right side of the first partial space 36a. The at least part of the partial side wall 34a has a spiral shape. The spiral shape is, for example, the involute curve 66. The center of the base circle 68 of the involute curve 66 is located on the axis A. The base circle 68 of the involute curve 66 passes through a maximum thickness portion of each strut 40 that has the maximum thickness. A start point 70 of the involute curve 66 is located at the intersection between the first imaginary line 62 and the base circle 68.

The partial side wall 34a extends along a portion of the involute curve 66. The portion of the involute curve 66 along which the partial side wall 34a extends is referred to as a partial involute curve 66a. In the present embodiment, the partial involute curve 66a is set as follows. The first imaginary line 62 is assumed to be an x-axis, the second imaginary line 64 is assumed to be a y-axis, and the position of the axis A is assumed to be an origin. Further, a range located on the right side of the origin is assumed to be a positive range of x, and a range located on the left side of the origin is assumed to be a negative range of x. A range located above the origin is assumed to be a positive range of y, and a range located below the origin is assumed to be a negative range of y. The x-axis direction is a first direction, and the y-axis direction is a second direction. In the present embodiment, in the involute curve 66 with an involute angle θ of 0 degrees to 180 degrees, a portion where the magnitude of the x component (the first direction component) of a radius (a radius vector) 80 of the involute curve 66 is maximized is defined as a start point 72 of the partial involute curve 66a. Further, in the involute curve 66 with an involute angle θ of 0 degrees to 180 degrees, a portion where the magnitude of the y component (the second direction component) of the radius 80 of the involute curve 66 is maximized is defined as an end point 76 of the partial involute curve 66a. The partial involute curve 66a includes a portion 74 where the magnitude of the x component of the involute curve 66 is zero. It should be noted that the position of the start point 72 and the position of the end point 76 of the partial involute curve 66a can be set arbitrarily. The entire shape of the partial side wall 34a may coincide with the shape of the involute curve 66 when viewed in the axial direction.

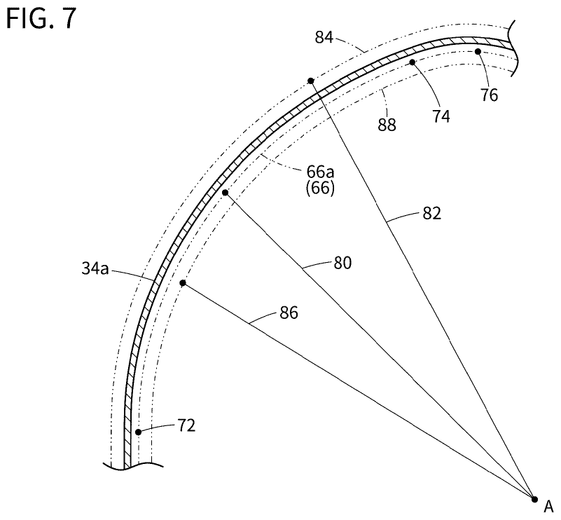

Note that the shape of at least a part of the partial side wall 34a does not need to completely coincide with the shape of the involute curve 66. It is sufficient that at least a part of the partial side wall 34a extends along the involute curve 66. For example, as shown in FIG. 7, a curve with a first radius 82 that is 2% longer than the radius 80 of the involute curve 66 is referred to as a first virtual curve 84. Further, a curve with a second radius 86 that is 2% shorter than the radius 80 of the involute curve 66 is referred to as a second virtual curve 88. A portion of the partial side wall 34a that is sandwiched between the portion thereof corresponding to the start point 72 of the partial involute curve 66a and the portion thereof corresponding to the end point 76 of the partial involute curve 66a may be located between the first virtual curve 84 and the second virtual curve 88.

### 5. Flow of Air in Intake Duct 28

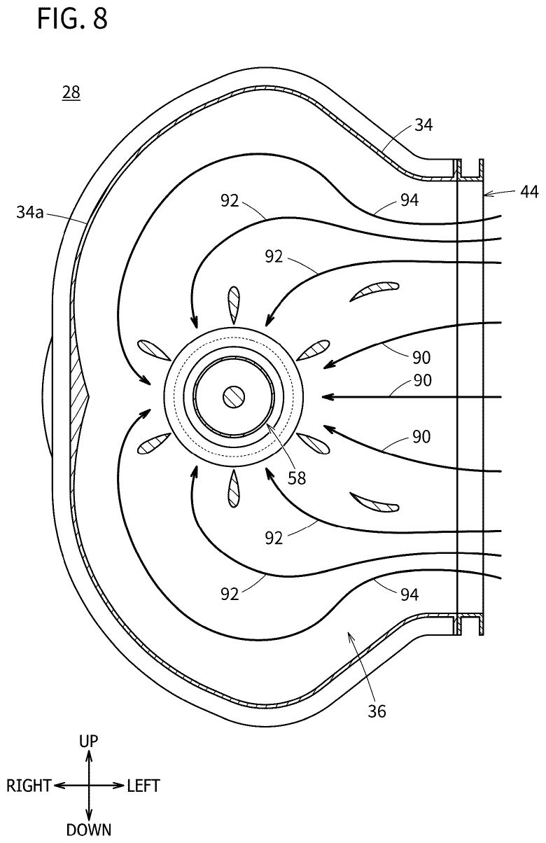

FIG. 8 is a diagram showing the flow of air in the intake duct 28. Partial air 90, which is a part of air flowing into the duct space 36 from the intake port 44, flows through a relatively short path and flows into the introduction path 58 from the left side. Partial air 92, which is a part of the air flowing into the duct space 36 from the intake port 44, flows through a path longer than the path through which the partial air 90 flows, and flows into the introduction path 58 from above (or below). Partial air 94, which is a part of the air flowing into the duct space 36 from the intake port 44, flows through a path longer than the path through which the partial air 92 flows, and flows into the introduction path 58 from the right side.

The lengths of the paths through which the partial air 90 and the partial air 92 flow are relatively short. Therefore, the partial air 90 and the partial air 92 easily flow into the introduction path 58. On the other hand, the length of the path through which the partial air 94 flows is relatively long. In addition, the partial air 94 receives resistance from the side wall 34. Therefore, the partial air 94 is usually less likely to flow into the introduction path 58.

In the present embodiment, at least a part of the partial side wall 34a extends along the involute curve 66. This makes it possible to reduce the resistance that the partial air 94 receives from the side wall 34, and to reduce the pressure loss of the partial air 94. As a result, the partial air 94 smoothly flows along the side wall 34.

As described above, according to the present embodiment, the partial air 94 can be smoothly guided to the position farthest from the intake port 44. Therefore, the unevenness of the intake air at the respective portions of the introduction path 58 in the circumferential direction is reduced. That is, according to the present embodiment, it is possible to suppress the unevenness of the intake air in the compressor 20, and as a result, it is possible to introduce the air into the compressor 20 in a favorable manner in the gas turbine engine 14 having the side air intake structure.

Further, since the cross-sectional area of the second partial space 36b is constant, turbulence of the air flowing into the first partial space 36a can be suppressed. As a result, it is possible to suppress the separation of the air from the guide vanes 42. Therefore, the effect of straightening the flow of the air using the guide vanes 42 can be improved.

### 6. Other Embodiment

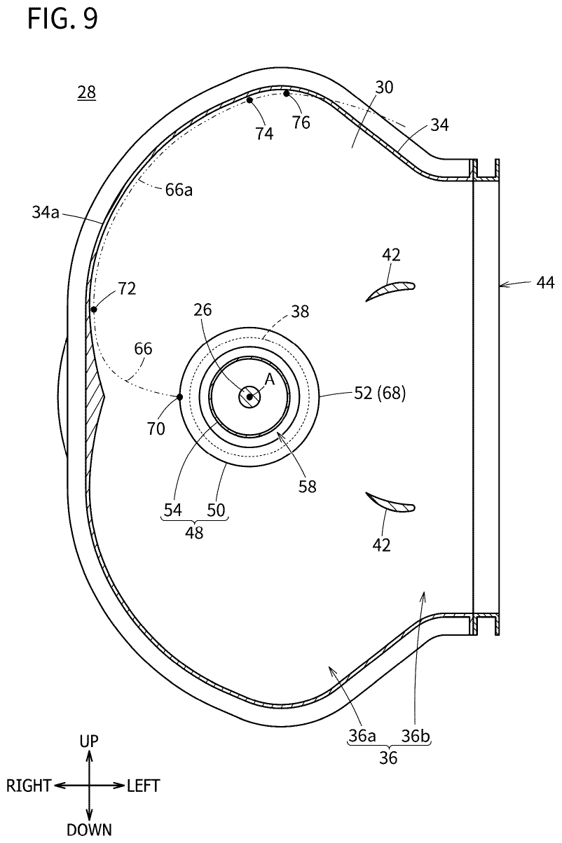

FIG. 9 shows another base circle 68. The base circle 68 of the involute curve 66 may be set based on the bell mouth 48. For example, as shown in FIG. 5, the outer circumferential circle of the distal end portion 52 of the outer shroud 50 or the outer circumferential circle of the distal end portion 56 of the inner shroud 54, whichever has a larger radius, may be the base circle 68 of the involute curve 66. FIG. 5 shows a mode in which a radius r1 of the outer circumferential circle of the distal end portion 52 of the outer shroud 50 is larger than a radius r2 of the outer circumferential circle of the distal end portion 56 of the inner shroud 54. In this case, as shown in FIG. 9, the outer circumferential circle of the distal end portion 52 of the outer shroud 50 is set as the base circle 68 of the involute curve 66. According to this embodiment, the base circle 68 can be set in the intake duct 28 that does not include the struts 40.

### 7. Flying Object

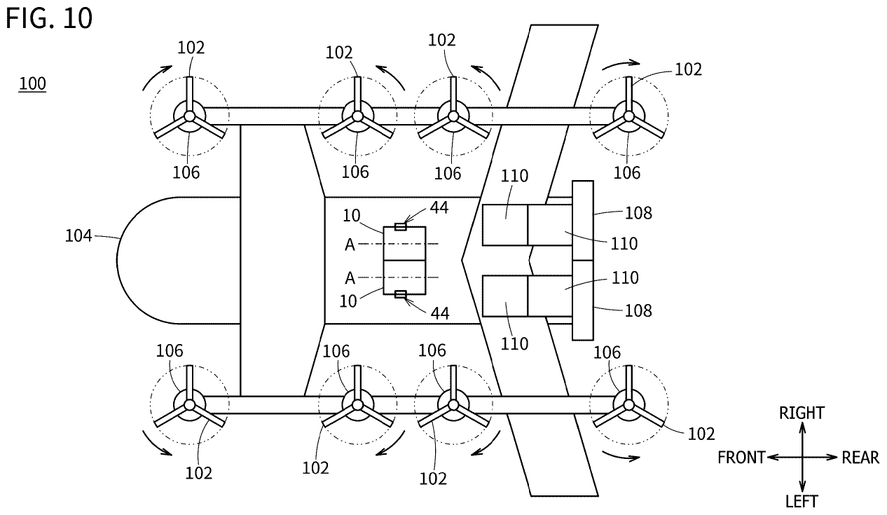

FIG. 10 is a schematic diagram of a flying object 100. The flying object 100 is an electric vertical take-off and landing aircraft (eVTOL aircraft). The flying object 100 includes eight VTOL rotors 102. The VTOL rotors 102 generate upward thrust for a fuselage 104. The flying object 100 includes eight electric motors 106. One electric motor 106 drives one VTOL rotor 102. The flying object 100 includes two cruise rotors 108. The cruise rotors 108 generate forward thrust for the fuselage 104. The flying object 100 includes four electric motors 110. Two electric motors 110 drive one cruise rotor 108.

The flying object 100 includes a plurality of the power generation units 10. The plurality of power generation units 10 are arranged in parallel inside the fuselage 104. That is, a plurality of the gas turbine engines 14 are arranged in parallel inside the fuselage 104. Each gas turbine engine 14 is disposed such that the axis A extends along the front-rear direction. Further, the intake port 44 of each intake duct 28 is disposed on the wall surface of the fuselage 104. Electric power generated by the generators 12 of the power generation units 10 is supplied to the electric motors 106 and 110.

### 8. Supplementary Notes

The following supplementary notes are further disclosed in relation to the above-described embodiments.

### Supplementary Note 1

The intake duct (28) of the present disclosure guides air to the compressor (20) of the gas turbine engine (14), and includes: the rear wall (30) provided with the opening (38) in which the introduction path (58) is disposed, the introduction path being configured to introduce the air into the compressor; the front wall (32) facing the rear wall; and the side wall (34) configured to connect the rear wall and the front wall, wherein the duct space (36) defined by the rear wall, the front wall, and the side wall includes the first partial space (36a) including the center of the opening, and the second partial space (36b) configured to guide, to the first partial space, the air flowing in the second partial space via the intake port (44), the second partial space is located on one side of the first partial space, at least a part of the partial side wall (34a), which is a part of the side wall, is located on another side of the first partial space, and the shape of the at least part of the partial side wall is a spiral shape when viewed in the axial direction of the gas turbine engine.

### Supplementary Note 2

In the intake duct according to Supplementary Note 1, the at least part of the partial side wall may be formed along the involute curve (66) when viewed in the axial direction of the gas turbine engine, and the center of the base circle (68) of the involute curve may be located on the axis (A) of the gas turbine engine.

### Supplementary Note 3

The intake duct according to Supplementary Note 2 may further include the plurality of struts (40) configured to connect the rear wall and the front wall, and when viewed in the axial direction of the gas turbine engine, the plurality of struts may be arranged at intervals from each other on the base circle, and the base circle may pass through a thickest portion of each of the struts.

### Supplementary Note 4

In the intake duct according to Supplementary Note 2, the part of the partial side wall that is formed along the involute curve may extend along at least the partial involute curve (66a) that is a part of the involute curve, and when a direction from the center of the base circle toward the start point (70) of the involute curve is defined as a first direction, the start point (72) of the partial involute curve may be a portion of the involute curve where the magnitude of the component of the involute curve in the first direction is maximized.

### Supplementary Note 5

In the intake duct according to Supplementary Note 4, the partial involute curve may reach at least the portion (74) of the involute curve where the magnitude of the component of the involute curve in the first direction is zero.

### Supplementary Note 6

In the intake duct according to Supplementary Note 4 or 5, when a direction orthogonal to the first direction is defined as a second direction, the partial involute curve may reach the portion (76) of the involute curve where the magnitude of the component of the involute curve in the second direction is maximized.

### Supplementary Note 7

In the intake duct according to Supplementary Note 6, when viewed in the axial direction of the gas turbine engine, a portion of the partial side wall that is sandwiched between a portion corresponding to the start point of the partial involute curve and a portion corresponding to the end point (76) of the partial involute curve may be located between the first virtual curve (84) with the first radius (82) that is 2% longer than the radius (80) of the involute curve, and the second virtual curve (88) with the second radius (86) that is 2% shorter than the radius of the involute curve.

### Supplementary Note 8

In the intake duct according to Supplementary Note 1, the dimension (D2) of the second partial space in the axial direction of the gas turbine engine may increase with increasing distance from the first partial space.

### Supplementary Note 9

In the intake duct according to Supplementary Note 1, in at least a part of the second partial space, the cross-sectional area of the second partial space may be constant while the cross-sectional shape of the second partial space changes with increasing distance from the first partial space.

### Supplementary Note 10

The intake duct according to Supplementary Note 1 may further include the guide vane (42) located between the opening and the intake port when viewed in the axial direction of the gas turbine engine, the guide vane being connected to the rear wall and the front wall.

### Supplementary Note 11

The intake duct according to Supplementary Note 2 may further include the bell mouth (48) including the outer shroud (50) and the inner shroud (54), and attached to the opening, and the base circle may be an outer circumferential circle having a larger radius among the outer circumferential circle of the distal end portion (52) of the outer shroud and the outer circumferential circle of the distal end portion (56) of the inner shroud.

### Supplementary Note 12

The gas turbine engine of the present disclosure includes the intake duct according to any one of Supplementary Notes 1 to 11.

### Supplementary Note 13

The flying object (100) of the present disclosure includes a plurality of the gas turbine engines according to any one of Supplementary Notes 1 to 12, and the plurality of gas turbine engines are arranged in parallel inside the fuselage (104).

Although the present disclosure has been described in detail, the present disclosure is not limited to the above-described individual embodiments. Various additions, replacements, modifications, partial deletions, and the like can be made to these embodiments without departing from the essence and gist of the present disclosure, or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. An intake duct that guides air to a compressor of a gas turbine engine, the intake duct comprising:
a rear wall provided with an opening in which an introduction path is disposed, the introduction path being configured to introduce the air into the compressor;
a front wall facing the rear wall; and
a side wall configured to connect the rear wall and the front wall,
wherein a duct space defined by the rear wall, the front wall, and the side wall includes a first partial space including a center of the opening, and a second partial space configured to guide, to the first partial space, the air flowing in the second partial space via an intake port,
the second partial space is located on one side of the first partial space,
at least a part of a partial side wall, which is a part of the side wall, is located on another side of the first partial space, and
a shape of the at least part of the partial side wall is a spiral shape when viewed in an axial direction of the gas turbine engine.

2. The intake duct according to claim 1, wherein
the at least part of the partial side wall is formed along an involute curve when viewed in the axial direction of the gas turbine engine, and
a center of a base circle of the involute curve is located on an axis of the gas turbine engine.

3. The intake duct according to claim 2, further comprising a plurality of struts configured to connect the rear wall and the front wall, wherein
when viewed in the axial direction of the gas turbine engine, the plurality of struts are arranged at intervals from each other on the base circle, and the base circle passes through a thickest portion of each of the struts.

4. The intake duct according to claim 2, wherein
the part of the partial side wall that is formed along the involute curve extends along at least a partial involute curve that is a part of the involute curve, and
when a direction from the center of the base circle toward a start point of the involute curve is defined as a first direction, a start point of the partial involute curve is a portion of the involute curve where a magnitude of a component of the involute curve in the first direction is maximized.

5. The intake duct according to claim 4, wherein
the partial involute curve reaches at least a portion of the involute curve where the magnitude of the component of the involute curve in the first direction is zero.

6. The intake duct according to claim 4, wherein
when a direction orthogonal to the first direction is defined as a second direction, the partial involute curve reaches a portion of the involute curve where a magnitude of a component of the involute curve in the second direction is maximized.

7. The intake duct according to claim 6, wherein
when viewed in the axial direction of the gas turbine engine, a portion of the partial side wall that is sandwiched between a portion corresponding to the start point of the partial involute curve and a portion corresponding to an end point of the partial involute curve is located between a first virtual curve with a first radius that is 2% longer than a radius of the involute curve, and a second virtual curve with a second radius that is 2% shorter than the radius of the involute curve.

8. The intake duct according to claim 1, wherein
a dimension of the second partial space in the axial direction of the gas turbine engine increases with increasing distance from the first partial space.

9. The intake duct according to claim 1, wherein
in at least a part of the second partial space, a cross-sectional area of the second partial space is constant while a cross-sectional shape of the second partial space changes with increasing distance from the first partial space.

10. The intake duct according to claim 1, further comprising a guide vane located between the opening and the intake port when viewed in the axial direction of the gas turbine engine, the guide vane being connected to the rear wall and the front wall.

11. The intake duct according to claim 2, further comprising a bell mouth including an outer shroud and an inner shroud, and attached to the opening, wherein
the base circle is an outer circumferential circle having a larger radius among an outer circumferential circle of a distal end portion of the outer shroud and an outer circumferential circle of a distal end portion of the inner shroud.

12. A gas turbine engine comprising the intake duct according to claim 1.

13. A flying object comprising a plurality of the gas turbine engines according to claim 12,
wherein the plurality of gas turbine engines are arranged in parallel inside a fuselage.
